(19) United States
(12) Patent Application Publication
(10) Pub. No.: US 2025/0382865 A1
(43) Pub. Date: Dec. 18, 2025

(54) VIBRATIONAL MODE AND SEVERITY DETERMINATIONS FOR DRILLING SYSTEMS

(71) Applicant: Halliburton Energy Services, Inc., Houston, TX (US)

(72) Inventors: Kaixiao TIAN, Singapore (SG); Bibek KABI, Bangalore (IN); Julien Christian MARCK, Houston, TX (US); Jeremy GREENWOOD, Houston, TX (US)

(73) Assignee: Halliburton Energy Services, Inc., Houston, TX (US)

(21) Appl. No.: 18/746,316

(22) Filed: Jun. 18, 2024

(51) Int. Cl. E21B 44/00; E21B 47/00; G01V 1/50

(52) U.S. Cl. CPC E21B 44/00; E21B 47/00; G01V 1/50

(57) ABSTRACT

Aspects of the subject technology relate to systems, methods, and computer readable media for determining or identifying one or more vibrational modes and corresponding severities experienced by a drilling system operating within a wellbore. Vibrational data comprising vibrational measurements of a vibrational mode is obtained from a component of a drilling assembly while the component is in a wellbore and performing one or more drilling operations. Cumulative vibrational information of the vibrational mode is determined based on the vibrational measurements, the cumulative vibrational information identifying and characterizing, for each of a plurality of instances during a time interval an accumulated severity of the vibrational mode. One or more drilling parameters of the drilling assembly is adjusted based on the cumulative vibrational information.

### TECHNICAL FIELD

The present technology pertains to determining or identifying one or more vibrational modes and corresponding severities experienced by a drilling system operating within a wellbore, and more particularly, to determine or identify the cumulative effect of the vibrational modes on the drilling system and to determine adjustments to one or more drilling parameters of the drilling system to reduce or eliminate the cumulative effect of the vibrational modes.

### BACKGROUND

In developing a borehole, such as for hydrocarbon production, scientific purposes, or other purposes, it can be important to know the relative risks for executing a drilling operation plan. Risks can impact various aspects of the drilling operation, such as the drilling assembly, the bit life, or the integrity of the drilling system. There can be impacts on the legal contract and liabilities therein (violation of legal contract requires management of change). There can be impacts on the performance, time, or cost of the drilling operation. There can be subterranean formation impacts, such as knowing the rock characteristics, identifying the relative location of nearby water or hydrocarbon reservoirs, knowing where the stratigraphic layers are, and other subterranean formation characteristics. There can be other impacts, such as on the rig and its equipment and systems. Within the oil and gas sector, many industry players have developed different digital advisors that provide recommendations in real-time to mitigate different risks. It would be beneficial to understand how the various risks impact drilling operations and what recommendations can be derived in real-time to direct future drilling operations by utilizing the advice from multiple digital advisors.

### BRIEF DESCRIPTION OF THE DRAWINGS

In order to describe the manner in which the features and advantages of this disclosure can be obtained, a more particular description is provided with reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1A illustrates an example schematic diagram of an example logging while drilling wellbore operating environment, in accordance with various aspects of the subject technology;

FIG. 1B illustrates an example schematic diagram of an example downhole environment having tubulars, in accordance with various aspects of the subject technology;

FIG. 2 illustrates an example system for determining or identifying cumulative vibrational information of a type or mode of vibration a drilling system may be experiencing while operating within a wellbore environment, in accordance with various aspects of the subject technology;

FIG. 3 illustrates a severity curve for an example vibrational mode over time;

FIG. 4 illustrates an accumulation severity curve for an example vibrational mode over time;

FIG. 5 illustrates an accumulation severity rate curve of an example vibrational mode over time;

FIG. 6 illustrates multiple severity curves for multiple example vibrational modes;

FIGS. 7-8 illustrate example impact maps for example vibrational modes;

FIGS. 9-11 illustrate example integrated impact maps for an example vibrational mode;

FIGS. 12-13 illustrate an example impact maps generated in real-time or near real-time;

FIG. 14 illustrates a flowchart for an example process for determining or identifying cumulative vibrational information of a type or mode of vibration a drilling system may be experiencing while operating within a wellbore environment, in accordance with various aspects of the subject technology;

FIG. 15 illustrates an example computing device architecture which can be employed to perform various steps, processes, and techniques disclosed herein.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

A drilling system, such as a rotary drilling system, may include a drill bit and a drill string. In some cases, while the drilling system is performing one or more drilling operations within a wellbore, the drilling system may experience different modes or types of vibration at different frequencies. For instance, while a rotary drilling system performs one or more drilling operations within a wellbore, the drillstring and drill bit can experience different modes of vibration at different frequencies. Moreover, severe forms of vibrations that a drilling system may experience, if left uncontrolled, may cause drilling dysfunctions that may cause damage to the drilling system. For instance, the drilling dysfunctions may cause damage to the mechanical components of the rotary drilling system and/or disrupt the actuation mechanism for the rotary steerable systems typically equipped in the bottomhole assembly (BHA) for directional drilling. Further, one or more advisory systems or monitoring systems associated with the drilling system may monitor vibrations the drilling system may be experiencing while the drilling system performs the drilling operations within the wellbore. In some instances, the advisory/monitoring systems may measure accelerations detected by one or more sensors of the drilling system (e.g., one or more sensors near the drill bit). The measured accelerations may indicate a type/mode of the vibrations experienced by the drilling system and the severity of vibrations the drilling system, such as the drillstring, may be experiencing. Moreover, the advisory/monitoring systems may notify or advise an operator of the drilling system of the type/mode of the vibrations and the severity of the type/mode of the vibrations, the drilling system may be experiencing. Based on the type/mode of the vibrations and the severity of the type/mode of the vibrations the drilling system may be experiencing, the operator and/or the monitoring/advisory systems may determine adjustments to one or more drilling parameters of the drilling systems to mitigate or reduce the severity of the type/mode of the vibrations the drilling system may be experiencing. Examples of drilling parameters the operator and/or the advisory/monitoring system may adjust, include but are not limited to weight-on-bit (WOB) and/or drillstring rotation speed (RPM) experience, flow rate, or rate of penetration (ROP). In some instances, the design of the drill bit, the BHA layout, the torque transmission of components of the drilling system, such a mud motor, and/or control mechanisms of the drilling system, such as a top drive control, may also mitigate the severity of the type/mode of vibrations the drilling systems may be experiencing.

However, aspects of the monitoring/advisory systems may constrain or limit the amount or number of measurements the monitoring or advisory systems may obtain. For example, a bandwidth of mud pulse telemetry may be limited and may constrain an amount of acceleration measurements the monitoring or advisory systems may obtain/generate within a unit time interval (e.g., low-frequency acceleration measurements). Moreover, real-time mitigation of drillstring vibrations using such constrained amount of acceleration measurements may be limited in its effectiveness. For instance, an operator and/or monitoring/advisory systems may make adjustments to one or more drilling parameters of a drilling system that may not adequately mitigate the severity of a type/mode of vibrations the drilling system is experiencing due to the low frequency or constrained amount of acceleration measurements.

Aspects of the disclosed technology address the foregoing problems by providing solutions for a physics-based interpolation of the low frequency or constrained amount of acceleration measurements to infer more information about a mode/type of vibrations, and/or severity of the mode/type of vibrations, a drilling system may be experiencing. For example, the disclosed technology may include determining cumulative vibrational information of vibrations the drilling system may be experiencing based on the low frequency or constrained amount of acceleration measurements. As described herein, the cumulative vibrational information may include information about a mode or type of vibration the drilling system may be experiencing for a duration of time and the severity of the mode or type of vibration the drilling system is experiencing. Moreover, the cumulative vibrational information may enable the operator of the drilling system and/or the monitoring/advisory system associated with the drilling system to determine adjustments to one or more drilling parameters of the drilling system that may more adequately mitigate the severity of the type/mode of vibrations the drilling system may be experience as compared to adjustments to the drilling parameters that are based on the low frequency or constrained amount of acceleration measurements. In some instances, the disclosed technology may take into account many dynamic or static limits, such as drilling envelopes.

In some examples, a method comprises obtaining, from a component of a drilling assembly while the component is in a wellbore and performing one or more drilling operations, vibrational data comprising vibrational measurements of a vibrational mode; determining cumulative vibrational information of the vibrational mode based on the vibrational measurements, the cumulative vibrational information identifying and characterizing, for each of a plurality of instances during a time interval an accumulated severity of the vibrational mode; and adjusting one or more drilling parameters of the drilling assembly based on the cumulative vibrational information.

In some examples, a system comprises a communications interface; a memory storing instructions; and at least one processor coupled to the communications interface and the memory, the at least one processor being configured to execute the instructions to: obtain, from a component of a drilling assembly while the component is in a wellbore and performing one or more drilling operations, vibrational data comprising vibrational measurements of a vibrational mode; determine cumulative vibrational information of the vibrational mode based on the vibrational measurements, the cumulative vibrational information identifying and characterizing, for each of a plurality of instances during a time interval an accumulated severity of the vibrational mode; and adjust one or more drilling parameters of the drilling assembly based on the cumulative vibrational information.

In various examples, a non-transitory computer-readable storage medium storing instructions that, when executed by at least one processor, cause the at least one processor to perform operations comprises obtaining, from a component of a drilling assembly while the component is in a wellbore and performing one or more drilling operations, vibrational data comprising vibrational measurements of a vibrational mode; determining cumulative vibrational information of the vibrational mode based on the vibrational measurements, the cumulative vibrational information identifying and characterizing, for each of a plurality of instances during a time interval an accumulated severity of the vibrational mode; and adjusting one or more drilling parameters of the drilling assembly based on the cumulative vibrational information.

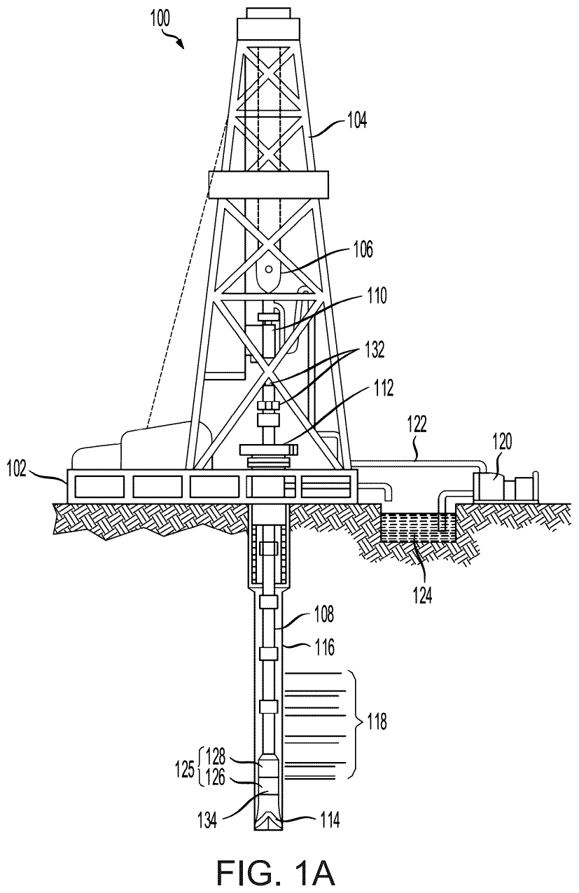

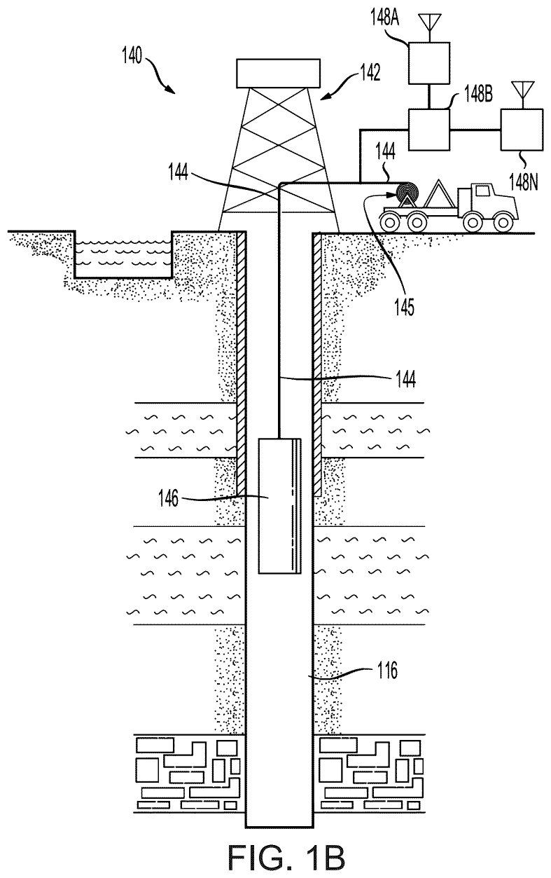

Turning now to FIG. 1A, a drilling arrangement is shown that exemplifies a Logging While Drilling (commonly abbreviated as LWD) configuration in a wellbore drilling scenario 100. Logging-While-Drilling typically incorporates sensors that acquire formation data and vibrational data. Specifically, the drilling arrangement shown in FIG. 1A can be used to complete one or more fracturing stages or operations of well site. Further, the drilling arrangement shown in FIG. 1A, as later described, may include on or more sensors, such as accelerometers, that may provide feedback related to vibrations the drilling arrangement may be experiencing while the one or more fracturing stages or operations are being completed. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As the both drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission. e.g, using mud pulse telemetry, EM telemetry, or acoustic telemetry. In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

Referring to FIG. 1B, an example system 140 is depicted for conducting downhole measurements after at least a portion of a wellbore has been drilled and the drill string removed from the well. An electromagnetic imager tool can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, the wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via the wireline conveyance 144 to meet power requirements of the tool. For slickline or coiled tubing configurations, power can be supplied downhole with a battery or via a downhole generator.

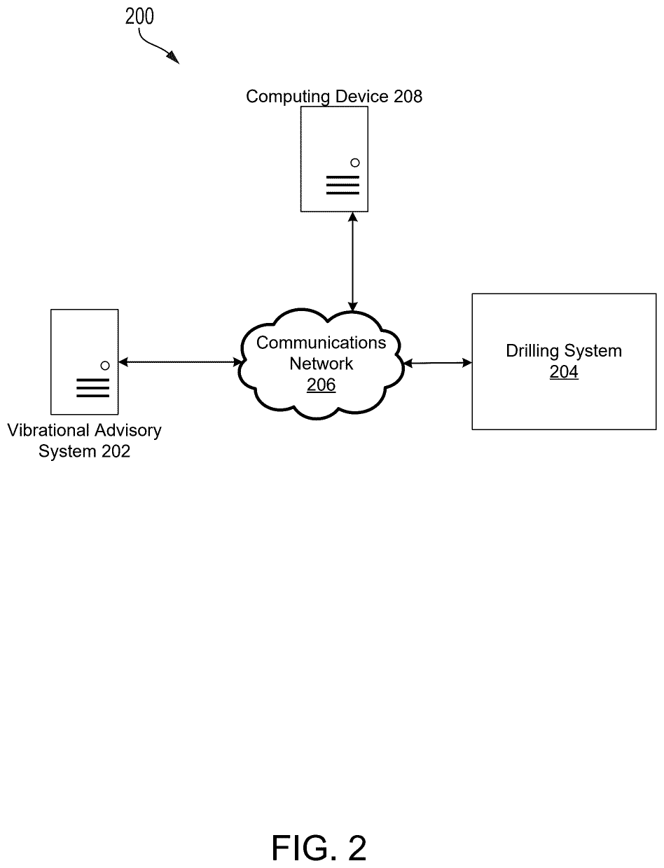

Referring to FIG. 2, the example system 200 may include vibrational advisory system 202, drilling system 204 and computing device 208. As described herein, vibrational advisory system 202 may perform any of the example processes described herein to, among other things, determine cumulative vibrational information of vibrations that drilling system 204 may be experiencing while performing one or more drilling operations within a wellbore (e.g., on-bottom drilling, off-bottom drilling, tripping in, tripping out, and other applicable drilling operations). As described herein, the cumulative vibrational information may identify and characterize a mode/type of vibration that drilling system 204, such as the drillstring of a rotary drilling system, may be experiencing. Moreover, the cumulative vibrational information may indicate a level of severity of the mode of vibration that drilling system 204 may be experiencing. In some cases, vibrational advisory system 202 may determine the cumulative vibrational information based on sensor measurements or acceleration measurements generated or determined by drilling system 204. In some instances, the sensor measurements or acceleration measurements may include low frequency or a constrained amount of sensor or acceleration measurements generated or determined by drilling system 204.

Moreover, vibrational advisory system 202 may represent a computing system that includes one or more servers and tangible, non-transitory memory devices storing executable code and application modules. The one or more servers may each include one or more processors or processor-based computing devices, which may be configured to execute portions of the stored code or application modules to perform operations consistent with the disclosed embodiments. Further, vibrational advisory system 202 may include a communications unit or interface coupled to the one or more processors for accommodating wired or wireless communication across one or more communications networks. Moreover, each of the computing systems and each of the computing devices of system 200 may be interconnected through any appropriate combination of communications networks, such as communications network 206.

Examples of communications network 206 include, but are not limited to, a wired connection, mud pulse telemetry, EM telemetry, acoustic telemetry, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. In some instances, the computing devices and computing systems operating within system 200 may perform operations that establish and maintain one or more secure channels of communication across communications network 160, such as, but not limited to, a transport layer security (TSL) channel, a secure socket layer (SSL) channel, or any other suitable secure communication channel.

Moreover, drilling system 204 of system 200 may include a drilling assembly, such as the drilling assembly of FIG. 1A. The drilling assembly may include one or more components, systems or devices that complete one or more fracturing stages or operations. As described herein, the drilling assembly of drilling system 204 may include a drill bit, a bottom-hole assembly (BHA) and a drillstring (e.g., drill bit 114, bottom-hole assembly 125 and drill string 108). Moreover, the BHA may include one or more sensors that collect/generate sensor data. In some cases, the sensor data may be associated with vibrations that the drilling assembly, such as the drillstring and/or the drill bit may be experiencing. For instance, the BHA may include one or more accelerometers that collect/generate accelerometer data. In such an instance, the accelerometer data may indicate accelerations or vibrations the drillstring and/or the drill bit may be experiencing. In some instances, the sensor data may be defined in three-dimensions. For instance, following the example above, the accelerometer data may indicate or identify, for one or more instances, accelerations in the X axis, accelerations in the Y axis, and/or accelerations in the Z axis.

Further, the BHA may include one or more computing devices communicatively coupled to the one or more sensors. In some aspects, the one or more computing devices of the BHA may generate sensor measurements based on the sensor data. For instance, the computing devices of the BHA may obtain accelerometer data from one or more accelerometers of the BHA. In some cases, the computing devices of the BHA may generate a sensor log or record of the sensor information, such as the accelerations, collected/detected by the sensors of the BHA based on the sensor data (e.g., the accelerometer data). In such cases, each entry of the sensor log or record may indicate the detected sensor information and a corresponding time of detection. Moreover, the computing devices of the BHA may determine one or more sensor measurements related to the vibrations or accelerations that the drilling assembly (e.g., the drill bit and/or the drillstring) may be experiencing based on the sensor data. For instance, based on the sensor log or record of the sensor information, such as the detected accelerations, the computing devices of the BHA may determine the sensor measurements. Examples of sensor measurements that the computing devices of BHA may determine include the mode/type of vibrations the drilling assembly may be experiencing, the severity of the mode/type of vibrations the drilling assembly may be experiencing, average X acceleration, the average Y acceleration, the average Z acceleration, the peak X acceleration, the peak Y acceleration, and/or the peak Z acceleration.

In some examples, the computing devices of the BHA may determine a mode/type of vibrations the drilling assembly may be experiencing based on a sensor log or record of accelerations detected by one or more accelerometers of the BHA. In such examples, the computing devices of the BHA may determine or identify, for each entry or instance identified in the sensor log, an X acceleration, a Y acceleration and/or a Z acceleration and corresponding timestamp. Based on the determined X acceleration, Y acceleration and/or Z acceleration and corresponding timestamp of each entry, the computing devices of the BHA may determine a corresponding mode of vibration. As described herein, each determined mode of vibration of each entry may indicate a mode of vibration the drilling assembly experiences at a particular time or instance. Moreover, the mode or of vibrations the drilling assembly may experience may be, for example, axial vibration, lateral vibration or torsional vibration. Examples of severe forms of modes of vibrations the drilling assembly may experience include, but are not limited to, low frequency torsional oscillation (Stick-Slip), high frequency torsional oscillation (HFTO), bit bounce, bit forward whirl, bit backward whirl, forward BHA whirl, backward BHA whirl, lateral shocks, modal coupling, and other applicable dysfunctions. In some instances, the computing devices of the BHA may generate a vibration log based on the determined modes of vibrations and corresponding timestamps. In such instances, the vibration log may identify, for each entry, a determined mode of vibration and corresponding timestamp. Moreover, the vibration log may identify the corresponding X acceleration, Y acceleration and/or Z acceleration of each determined mode or type of vibration.

In some examples, the computing devices of the BHA may, for each time of detection, determine a severity level for the corresponding mode/type of vibration the drilling assembly may be experiencing based on the vibration log. In such examples, for each entry in the vibration log, the computing devices of BHA may determine the severity level of the corresponding mode or type of vibration based on the corresponding X acceleration values, Y acceleration value and/or Z acceleration value. As described herein, the determined severity level of the mode or type of vibration may be a metric indicating a level of consequence or damage to the drilling assembly if the corresponding mode or type of vibration is ignored or not mitigated. In some instances, the severity level may be a value. For instance, the severity level may be within a range of 0 and 1. In such an instance, 0 may indicate there is low risk or no consequence to the drilling assembly if the corresponding mode or type of vibration is ignored or not mitigated, while 1 indicates there is a high or severe risk of consequence to the drilling assembly if the corresponding mode or type of vibration is ignored or not mitigated. In some instances, the severity level may be on a relative or absolute scale. In some aspects, the computing devices of the BHA may update the vibration log to include the determined severity levels. The updated vibration log may identify, for each entry, a determined mode or type of vibration, corresponding determined severity level and corresponding timestamp. In some cases, the computing devices of BHA may generate vibrational data comprising the updated vibration log. The vibrational data can be stored, along with other drilling data, as ADI files.

In some cases, the computing devices of the BHA may utilize other data when determining the mode or type of vibration the drilling assembly may be experiencing and/or the corresponding severity level. Examples of other data used by the computing devices of the BHA include, but are not limited to, drill bit RPM data, surface RPM, torque, and/or hook load data. In such cases the other data may be obtained from other types of sensors that may be included in the BHA. For example, surface torque can be measured indirectly based on electric current at the top drive. Further, strain gauges can be used to make measurements including weight-on-bit, torque-on-bit, and bending moment-on-bit.

Moreover, the BHA may include a communications interface, such as a telemetry sub 128 of FIG. 1A. As described herein, the BHA may transmit or transfer the vibrational data including the updated vibration log to vibrational advisory system 202 via the communications interface (e.g., wired, such as a wired drill pipe, or wireless signal transmission, such as mud pulse telemetry, EM telemetry, or acoustic telemetry). Further, vibrational advisory system 202 may determine cumulative vibrational information of the vibrations that drilling system 204 may be experiencing while performing one or more drilling operations within a wellbore based on the vibrational data. In some instances, the communications interface may store the updated vibration log data for later retrieval by vibrational advisory system 202 when the BHA is recovered. In such instances, vibrational advisory system 202 may be on the surface.

Further, the communications interface of the BHA may receive commands from one or more computing devices and/or computing systems. In some examples, the BHA may receive commands or instructions from computing system 306 or vibrational advisory system 202. In such examples, the commands or instructions may be associated with one or more drilling parameters of the drilling assembly. For instance, the commands or instructions may indicate set points or values of one or more drilling parameters (e.g., WOB and/or RPM of the drillstring rotation speed) or adjustments to the set points or values. As described herein, the adjustments may be based on the cumulative vibrational information determined or generated by vibrational advisory system 202.

In some instances, vibrational advisory system 202 may determine the set points or values of one or more drilling parameters or adjustments to the set points or values based on the cumulative vibrational information determined or generated by vibrational advisory system 202. For instance, vibrational advisory system 202 may generate or determine the cumulative vibrational information based on the vibrational data. In such an instance, vibrational advisory system 202 may determine set points or values of the drilling parameters or adjustments to the set points or values based on the cumulative vibrational information. Moreover, vibrational advisory system 202 may transmit commands or instructions including the determined set points or values of the drilling parameters or adjustments to the set points or values to the BHA. Further, the BHA may operate corresponding components of the drilling assembly in accordance with the determined set points or values of the drilling parameters or adjustments to the set points or values.

In some instances, computing device 208, may determine the set points or values of one or more drilling parameters or adjustments to the set points or values based on the cumulative vibrational information determined or generated by vibrational advisory system 202. For instance, vibrational advisory system 202 may generate or determine the cumulative vibrational information based on the vibrational data. In such an instance, vibrational advisory system 202 may transmit the cumulative vibrational information to computing device 208. Moreover, an operator or one or more processors of computing device 208 may determine the set points or values of the drilling parameters or adjustments to the set points or values based on the cumulative vibrational information. Further, computing device 208 may transmit commands or instructions including the determined set points or values of the drilling parameters or adjustments to the set points or values to the BHA. As described herein, the BHA may operate corresponding components of the drilling assembly in accordance with the determined set points or values of the drilling parameters or adjustments to the set points or values. In some instances, and as described herein, computing device 208 may display the cumulative vibrational information (e.g., impact maps).

In some aspects, vibrational advisory system 202 may determine the cumulative vibration information by determining or defining a time interval that includes multiple detected instances of acceleration or vibration that may be experienced by the drilling assembly. In some instances, the computing devices of the BHA may determine or define the time interval. In some instances, the time interval may be associated with a particular mode of vibration. Moreover, the time interval may include the start or first instance of a particular mode of vibration detected by the computing devices of the BHA. For instance, the computing devices of the BHA may parse the updated vibration log of the vibrational data to identify, for a particular type or mode of vibration the drilling assembly may be experiencing, a first instance or time a severity level (e.g., a value corresponding to the severity level) is equal to or greater than a first threshold severity level (e.g., a value corresponding to the first threshold severity level), such as 0.

In one aspect, in determining the start and end of a vibration event, a metric of severity levels can be utilized. The metric can be events and a severity alarm (e.g., severe stick-slip) derived from accelerations and downhole RPM or raw accelerations and downhole RPM. In other aspects, the metric can be a combination of the immediate aforementioned description with the inclusion of surface indicators such as surface RPM, surface torque, hookload and/or downhole indicators such as depth of cut per bit revolution.

Additionally, or alternatively, the time interval may include the end or the last instance of a particular mode of vibration detected by the computing devices of the BHA. For instance, the computing devices of the BHA may parse the updated vibration log of vibrational data to identify, for a particular mode of vibration the drilling assembly may be experiencing, an instance or time after the first instance or time a severity level (e.g., a value corresponding to the severity level) that is less than a second threshold severity level (e.g., a value corresponding to the second threshold severity level), such as 0.1.

The start and end of a mode of vibration can be determined through an applicable technique. Specifically, the start and end of a mode of vibration can be determined based on severity levels associated with a particular mode of vibration. For example, a severe Stick-slip can be indicative of a start of a Stick-slip event. A severity level of a mode of vibration can be determined from an applicable source, such as accelerations and downhole RPM, raw accelerations and downhole RPM, surface RPM, surface torque, hookload, and downhole indicators, such as depth of cut per bit revolution.

In cases where the time interval includes both the start or first instance of a particular mode of vibration a drilling assembly may be experiencing and the end or last instance of the particular mode of vibration the drilling assembly may be experiencing, the time interval may characterize a vibrational event of the particular type or mode of vibration. Further, the computing devices of the BHA may further include in the updated vibration log, data indicating the time interval including the vibrational event or the duration of the vibrational event. In some instances, vibrational advisory system 202 may perform any of the above described example processes to determine or define the time interval that includes the multiple detected instances.

In one example, the time interval can be a reaction time for mitigation. As follows, if the time interval is small, the time interval can indicate a frequent active response to the vibration indicators which may not be desirable as the vibration indicator can be inaccurate and/or from the operational perspective, it is not practical to adjust the drilling parameters at a high frequency.

By default, D is taken as 10 min, and the user has the freedom to adjust the parameter on the fly.

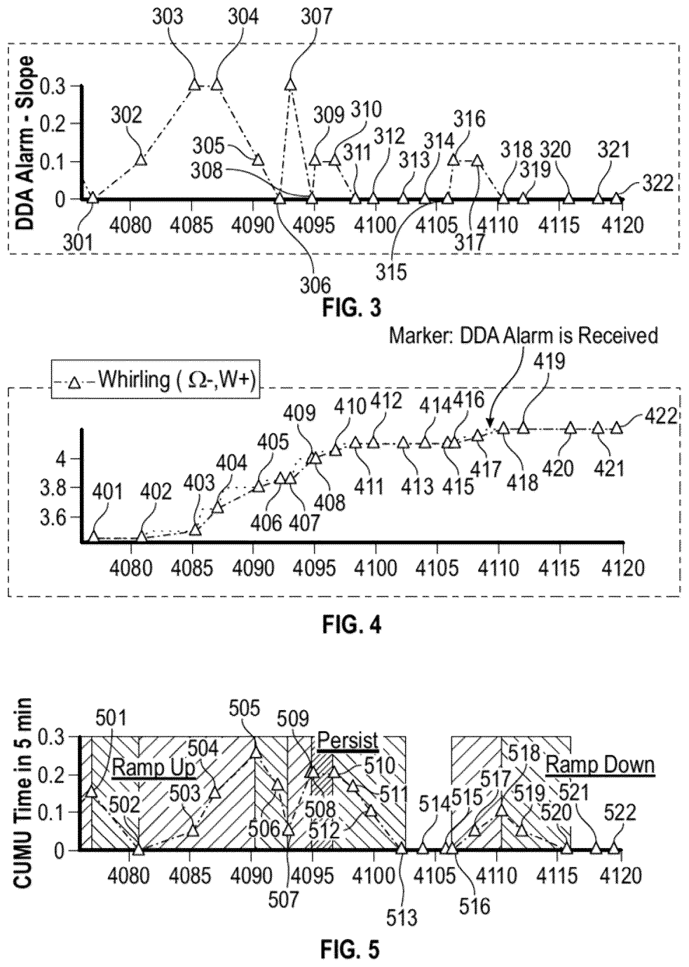

Referring to FIG. 3, example graph 300 illustrates a severity curve for an example vibrational mode whirling that drilling assembly may be experiencing during a time interval defined or determined by the computing devices of the BHA or vibrational advisory system 202. Moreover, the time interval and/or graph 300 may be based on a corresponding updated vibration log. As illustrated in FIG. 3, the X axis may correspond to time (e.g., seconds) and the Y axis may correspond to severity level. As described herein, the time interval illustrated in graph 300 may include multiple detected instances of whirling that the drilling assembly may be experiencing. Each data point (e.g., datapoint 301-datapoint 322) may correspond to an entry in the updated vibration log within the determined or defined time interval. For instance, datapoint 301 may correspond to an entry of time 4080 seconds of the updated vibration log and may indicate the acceleration detected at time 4080 seconds corresponds to a severity level of 0. Moreover, datapoint 303 may correspond to an entry of time 4085 seconds of the updated vibration log and may indicate the acceleration detected at time 4085 seconds corresponds to a severity level of 0.3.

In some aspects, the cumulation vibrational information may, for each instance a particular mode of vibration a drilling assembly may be experiencing, indicate a corresponding cumulative severity level. In some instances, the cumulative severity level may be based on the defined time interval. For example, based on the updated vibration log, vibrational advisory system 202 may determine, for each datapoint or entry of the updated vibration log and within the defined time interval, a severity level of each subsequent entry or datapoint based on corresponding or associated timestamp of each entry or datapoint. Moreover, for each datapoint or entry of the updated vibration log, vibrational advisory system 202 may determine the combined or cumulative summation of the severity levels of each of the subsequent entry or datapoint including the severity level of the corresponding datapoint or entry. Further, vibrational advisory system 202 may generate cumulative vibrational information that includes, for each datapoint or entry of the updated vibration log, the combined or cumulative summation of the severity levels of each of the subsequent entry or datapoint including the severity level of the corresponding datapoint or entry.

Referring to FIG. 4, example graph 400 illustrates a severity accumulation curve for an example vibrational mode whirling. The average severity rate curve is based on the datapoints or entries of the corresponding updated vibration log within the defined time interval as illustrated in FIG. 3. As described herein, vibrational advisory system 202 may determine the combined or cumulative summation of severity levels for each datapoint or entry of updated vibration log as illustrated in FIG. 4. Each datapoint of graph 400 (e.g., datapoints 401-422) corresponds to a datapoint of graph 300. For instance, datapoint 401 represents the combined or cumulative summation of severity levels up until datapoint 301, datapoint 410 represents the combined or cumulative summation of severity levels up until datapoint 310, and datapoint 420 represents the combined or cumulative summation of severity levels up until datapoint 320. Moreover, as illustrated in FIG. 4, the X axis may correspond to time (e.g., seconds) and the Y axis may correspond to the combined severity level.

Referring back to FIG. 2, the cumulation vibrational information may characterize, for a particular mode or type of vibration a drilling assembly may be experiencing, an accumulation severity rate for any or one or more datapoints or entries of the updated vibration log within the defined time interval. In some aspects, the accumulation severity rate for the datapoints or entries of the updated vibration log may be based on the cumulative severity level a drilling assembly may have experienced or is experiencing. For example, as described herein, vibrational advisory system 202 may, for one or more datapoints or entries of the updated vibration log within the defined time interval, determine the combined or cumulative summation of the severity levels of each of the subsequent entries or datapoints including the severity level of the corresponding datapoint or entry. Moreover, for each of the one or more datapoints or entries of the updated vibration log within the defined time interval, vibrational advisory system 202 may determine the rate of change or the accumulation severity rate based on each determined cumulative summation of severity levels of the associated subsequent entries or datapoints including the severity level of the corresponding datapoint or entry. In some instances, vibrational advisory system 202 may determine, for each of the one or more datapoints or entries of the updated vibration log within the defined time interval, the average rate of accumulation for each of the any or one or more datapoints or entries within the defined time interval using the following equation:

$${ϕ}_{D}^{j} = \frac{{t}^{j} ( t ) - {t}^{j} ( t - D )}{D} \qquad ( eq . 1 )$$

where

$${ϕ}_{D}^{j}$$

is the value and its slope or rate of change with respect to time

$$d {ϕ}_{D}^{j} / dt$$

(e.g., accumulation severity rate) for each of the datapoints or entries of the updated vibration log within the defined time interval, t is passage of time, j is the drilling dysfunctions, t^{j} is the accumulation time for mode j (summation of the duration of mode j).

$${α}_{i}^{j}$$

is the corresponding array or severity for each mechanism of drilling dysfunctions j, and D is the defined time interval or time window. Further, vibrational advisory system 202 may generate cumulative vibrational information that includes the accumulation severity rate for each of the datapoints or entries of the updated vibration log within the defined time interval. As described herein, the greater the accumulation severity rate the more intense the accumulation of vibrations the drilling assembly may be experiencing or have experienced.

The defined time interval is a mitigation reaction time for responding to events. The time interval can be defined for a default time, e.g. ten minutes. Further the time interval can be adjusted, e.g. in real time or near-real time, by adjusting drilling parameters in response to the occurrence of events in order to attempt to mitigate the drilling events. The drilling parameters can be adjusted at a reasonable rate to define the time interval. Specifically, a user or system can refrain from adjusting the drilling parameters at a high frequency, to ensure practicality from an operational perspective, and accuracy of vibration indicators.

Referring to FIG. 5, example graph 500 illustrates an accumulation severity rate curve for an example vibrational mode whirling. The accumulation severity rate curve is based on the datapoints or entries of the corresponding updated vibration log within the defined time interval of FIG. 3. As described herein, vibrational advisory system 202 may determine the accumulation severity rate curve for any of the datapoints within the defined interval, as illustrated in FIG. 3, using equation 1. Each datapoint of graph 500 (e.g., datapoints 501-522) corresponds to a datapoint of graph 300. For instance, datapoint 501 represents the accumulation severity rate of datapoint 301, datapoint 502 represents the accumulation severity rate of datapoint 302, and datapoint 503 represents the accumulation severity rate of datapoint 303. Moreover, as illustrated in FIG. 5, the X axis may correspond to time (e.g., seconds) and the Y axis may correspond to severity level.

In some instances, the cumulation vibrational information may characterize characteristics of the average severity rate of one or more datapoints or entries of the updated vibration log within the defined time interval. In such instances, vibrational advisory system 202 may determine characteristics of the accumulation severity rate of each of one or more datapoints or entries of the updated vibration log within the defined time interval with respect to time based on the corresponding accumulation severity rate (e.g., the corresponding value). Examples of the characteristics of the accumulation severity rate include, but are not limited to, a ramp-down characteristic, a persistence characteristic or no change or event characteristic.

For example, and referring to FIG. 5, for the datapoints or corresponding entries of the updated vibration log within the defined time interval of graph 500, vibrational advisory system 202 may determine the accumulation severity rates of datapoints correspond to a ramp-up characteristic if

$${ϕ}_{D}^{j} > 0 , d {ϕ}_{D}^{j} / dt > 0$$

where vibration mode j increases in its combined severity

$$( e . g . , {α}_{t}^{j} Δ t )$$

within the past D minutes (e.g., see datapoint 503 and datapoint 504). In another example, for the datapoints or corresponding entries of the updated vibration log within the defined time interval of graph 500, vibrational advisory system 202 may determine the accumulation severity rates of datapoints correspond to a ramp down characteristic if

$${ϕ}_{D}^{j} < 0 , d {ϕ}_{D}^{j} / dt < 0$$

where there is no occurrence of mode j more than D minutes (e.g., see datapoint 519 and datapoint 520). In another example, for the datapoints or corresponding entries of the updated vibration log within the defined time interval of graph 500, vibrational advisory system 202 may determine the average severity rates of datapoints correspond to a persistence characteristic if

$${ϕ}_{D}^{j} > 0 , d {ϕ}_{D}^{j} / dt = 0$$

where there is no further occurrence of mode j in the past D minutes (e.g., see datapoint 508, datapoint 509, and datapoint 510). In another example, for the datapoints or corresponding entries of the updated vibration log within the defined time interval of graph 500, vibrational advisory system 202 may determine the average severity rates of datapoints correspond to a no event or no change characteristic if

$${ϕ}_{D}^{j} = 0$$

where drilling is free from mode j for D minutes (e.g., datapoint 521 and datapoint 522).

In some instances, a tool life or component life may be taken into account when determining cumulative vibrational information. In such instances, based on the updated vibration log, the severity levels for a particular type or mode of vibration except for the most severe, may be ignored (e.g.,

$${α}_{i}^{j}$$

may be 0 and for i≠1). As such, the time stamp and corresponding time accumulation for the most severe levels of vibrations for a particular mode/type of vibration remain. Readily, taking the summation of all the time accumulation for mechanism j results in the total time accumulation τ^{j}. Typically for the design of service, the maximum tool life T^{j} for mechanism j is available. With this, the cumulative damage can be defined as:

$$g ( {τ}^{j} ) = \{ \begin{matrix}\frac{{τ}^{j}}{{T}^{j}} , & {τ}^{j} < {T}^{j} \\ 1 , & {τ}^{j} \geq {T}^{j}\end{matrix}$$

where the ratio of t/T will indicate how close you are to the end of the life of the tool. For instance, the closer the ratio of t/T is to the value of 1, the closer the end of the life of the tool.

Referring to FIG. 2, and in some instances, vibrational advisory system 202 may generate display data based on the updated vibration log and/or the cumulative vibrational information. As described herein the display data may enable a computing device, such as computing device 208 to display the severity curve, accumulation severity curve and/or the accumulation severity rate curve of a particular mode/type of vibration the drilling assembly may be experiencing. For instance, vibrational advisory system 202 may provide the display data to computing device 208 to cause computing device 208 to display a severity curve for one or more modes or types of vibrations a drilling assembly may be experiencing, such as the severity curve of graph 300. In another instance, vibrational advisory system 202 may provide the display data to computing device 208 to cause computing device 208 to display an accumulation severity curve for one or more modes or types of vibrations a drilling assembly may be experiencing, such as the accumulation severity curve of graph 400. In another case, vibrational advisory system 202 may provide the display data to computing device 208 to cause computing device 208 to display an accumulation severity rate curve for one or more modes or types of vibrations a drilling assembly may be experiencing, such as the accumulation severity rate curve of graph 500. In some cases, vibrational advisory system 202 may generate and provide the display data to the computing device after the drilling assembly has ceased operations. In some cases, vibrational advisory system 202 may provide such display data in real time. As such, the computing device may display the severity curve, the severity accumulation severity curve and/or the accumulation severity rate curve for one or more modes or types of vibrations the drilling assembly may be experiencing in real time. The severity curve can be generated from the received log, e.g. quantity v. time, by assuming the logs are zero before the starting time of the log.

In some aspects, the display data may enable a computing device, such as computing device 208 to display the severity curve, accumulation severity curve and/or the accumulation severity rate curve of various modes or types of vibrations the drilling assembly may be experiencing. Referring to FIG. 6, display data generated by vibrational advisory system 202 may cause computing device 208 to display an accumulation severity rate curve of various modes or types of vibrations the drilling assembly may be experiencing. As illustrated in FIG. 6, example graph 600 includes accumulation severity rate curve 601 associated with stick slip, accumulation severity rate curve 602 associated with whirling, accumulation severity rate curve 603 associated with bit bounce, accumulation severity rate curve 604 associated with lateral shock, and accumulation severity rate curve 605 associated with a dynamic drilling advisor system (herein “DDA”). As described herein, vibrational advisory system 202 may determine the severity levels and/or cumulation vibrational information for various modes or types of vibrations the drilling assembly may be experiencing or has experienced. The vibrational advisory system 202 may, based on the determined severity levels and/or cumulation vibrational information, generate display data that enables the computing device to display the severity curve, accumulation severity curve and/or the accumulation severity rate curve of various modes or types of vibrations the drilling assembly may be experiencing.

Referring back to FIG. 2, vibrational advisory system 202 may generate impact maps based on the cumulative vibrational information. As described herein, an impact map may be a representation of a relationship of the severity level of a particular mode/type of vibration a drilling assembly may have experienced or is experiencing and one or more drilling parameters of the drilling assembly. Moreover, the impact map may indicate, for a particular mode/type of vibration a drilling assembly may be experiencing or is experiencing, the responsiveness of the severity level to a setpoint or value of a drilling parameter. In some instances, the impact map may indicate that the setpoint or value of the drilling parameter may cause the corresponding component of the drilling assembly to operate in a safe operating state, an intermediate operating state, or a dangerous operating state, relative to the severity level of the mode/type of vibration.

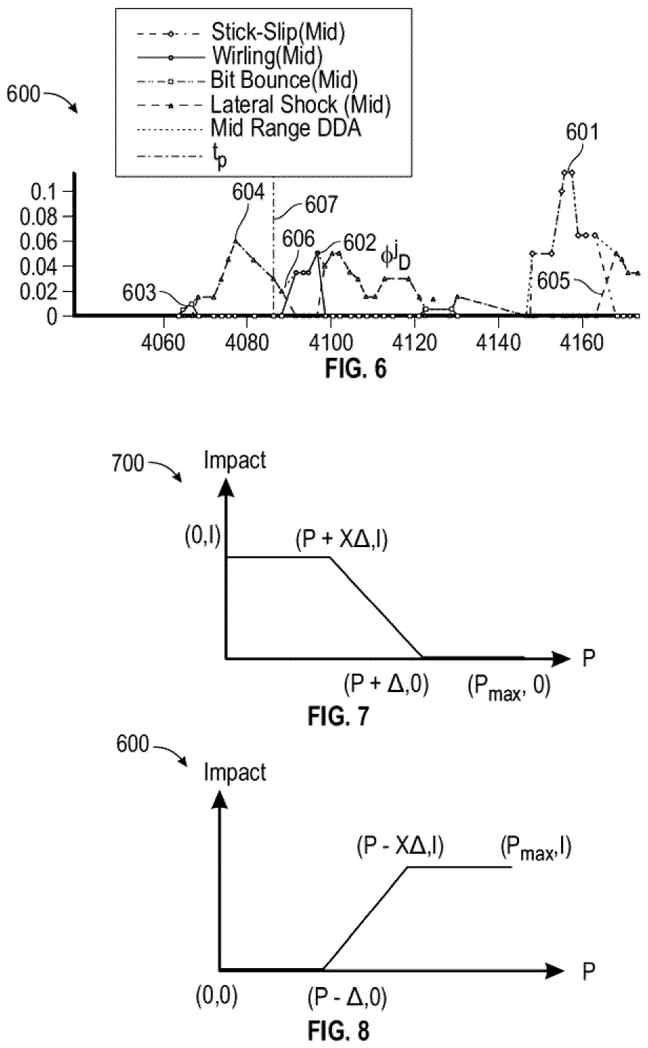

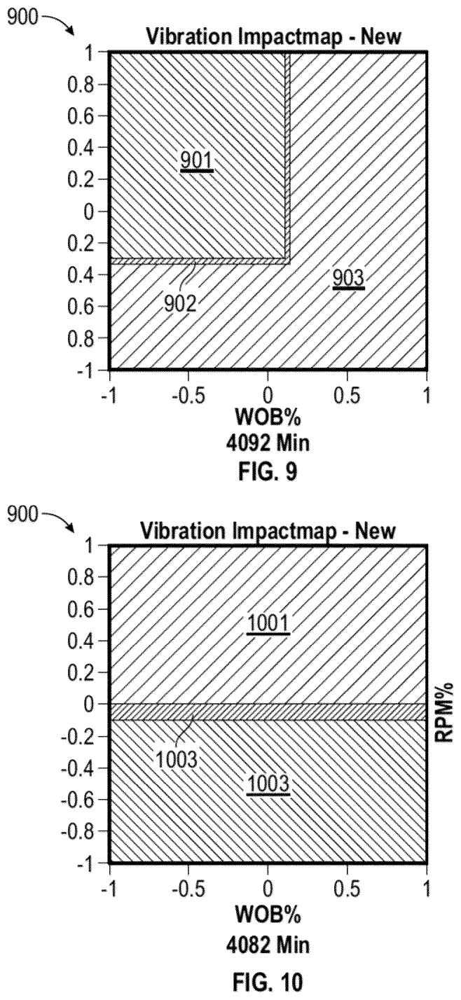

Referring to FIG. 7, is a graph of an impact map 700 showing the impact assignments for a drilling parameter P. FIG. 8 is another graph of an impact map 800 showing the impact assignments for a drilling parameter P. P can be in the context of vibration mitigation for drilling and include WOB and RPM. I is the impact value for vibration if left unaltered.

With respect to the impact map 700 shown in FIG. 7, increasing P mitigates the vibration, e.g. reducing impact from 1 to 0. With respect to the impact map 800 shown in FIG. 8, reducing P mitigates the vibration, e.g. reducing impact from 1 to 0. Δ is the amount of change in P to mitigate the vibration by a certain amount, e.g. by default it's 10% of the maximum P (i.e. P_max). Parameter 0=<χ<=1 controls the “stiffness” of the boundary, e.g., if the vibration is more severe, χ is larger (closer to 1), thereby leading to a steeper drop in impact value when adjusting P.

For stick-slip, WOB can be decreased, e.g. P=WOB as shown in FIG. 8. Further, for stick-slip, RPM can be increased, e.g. P=RPM as shown in FIG. 7. For whirling, WOB can be increased, e.g. P=WOB as when in FIG. 7. Further, for whirling, RPM can be decreased, e.g. P=RPM as shown in FIG. 8.

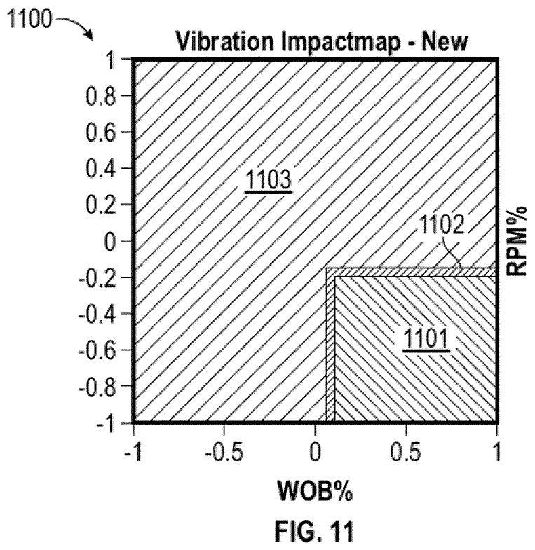

Further, the impact map may identify one or more zones associated with the safe operating state, an intermediate operating state, or a dangerous operating state. Referring to FIG. 9 example impact map 900 illustrates an example relationship of the severity level of slip stick experienced by the drilling assembly and a drilling parameter associated with WOB. As illustrated in FIG. 9, first zone 901 may be associated with a safe operating state of a component associated with the WOB drilling parameter, second zone 902 may be associated with an intermediate operating state of a component associated with WOB drilling parameter, and third zone 903 may be associated with a dangerous operating state of the component associated with WOB drilling parameter. As illustrated in FIG. 9, the X axis is associated with the variation (percentage of change) of WOB with respect to its current value, and Y axis is associated with the variation of RPM with respect to its current value. As described herein, the intermediate operating state or the second zone may correspond to the slope of an impact map similar to impact map 700 or impact map 800. Moreover, the thickness of the second zone may correspond to how steep or sharp the slope is in the corresponding impact map similar to impact map 700 or impact map 800. For instance, the greater the slope (or steeper/sharper) the narrower the second zone. Further and as illustrated in FIG. 9, decreasing the set point or value of the drilling parameter associated with WOB may cause the corresponding component of the drilling assembly to operate in a safe operating state, while increasing the set point or value of the drilling parameter associated with WOB may cause the corresponding component of the drilling assembly to operate in a dangerous operating state.

In some instances, the impact map may be a one, two, three, or higher dimensional relationship. In some cases, the impact map may be a mathematical representation, a graphical representation or a data relationship (such as stored in a database, data file, or other type of data relationship) stored on a computing system, file system, or other computing storage system. In some examples, vibrational advisory system 202 or computing device 208 determine adjustment for one or more drilling parameters of a drilling assembly based on the impact maps.

In some aspects, vibrational advisory system 202 may combine individual impact maps (e.g., impact maps representing a relationship between severity levels of a particular mode/type of vibration a drilling assembly map be experiencing or has experienced and a particular drilling parameter). As described herein, the combined impact map or integrated impact map may illustrate a relationship between multiple drilling parameters of the drilling assembly and severity levels of a particular mode/type of vibration a drilling assembly map be experiencing or has experienced. Referring to FIG. 10, example integrated impact map 1000 may illustrate the relationship between a drilling parameter associated with WOB, a drilling parameter associated with the RPM of the drillstring rotation speed and a severity level of a mode/type of vibration a drilling assembly may be experiencing or has experienced (e.g., whirling, slip stick, etc.). As illustrated, first zone 1001 may be associated with a safe operating state of components associated with the WOB drilling parameter and the drilling parameter associated with the RPM of the drillstring rotation speed, second zone 1002 may be associated with an intermediate operating state of the components associated with the WOB drilling parameter and the drilling parameter associated with the RPM of the drillstring rotation speed, and third zone 1003 may be associated with a dangerous operating state of the components associated with the WOB drilling parameter and the drilling parameter associated with the RPM of the drillstring rotation speed. As illustrated in FIG. 10, the X axis is associated with the variation (percentage of change) of WOB with respect to its current value, and Y axis is associated with the variation of RPM with respect to its current value.

The second zone 1002 can be identifying using an applicable interpolation technique. Specifically, WOB and RPM can be assumed to be independently associated with the impact value. For a given time, 2 1-D drilling parameter v. impact maps exist. Through interpolation, these 2 1-D maps can be combined into 1 2-D map.

Referring to FIG. 11, example integrated impact map 1000 may illustrate the relationship between a drilling parameter associated with WOB, a drilling parameter associated with the RPM of the drillstring rotation speed and a severity level of a mode/type of vibration a drilling assembly may be experiencing or has experienced (e.g., whirling, slip stick, etc.). As illustrated in FIG. 11, the X axis is associated with the variation (percentage of change) of WOB with respect to its current value, and Y axis is associated with the variation of RPM with respect to its current value. Different zones shown in the impact map 1000 correspond to different severity levels. As illustrated, first zone 1101 may be associated with a safe operating state of components associated with the WOB drilling parameter and the drilling parameter associated with the RPM of the drillstring rotation speed, second zone 1102 may be associated with an intermediate operating state of the components associated with the WOB drilling parameter and the drilling parameter associated with the RPM of the drillstring rotation speed, and third zone 1103 may be associated with a dangerous operating state of the components associated with the WOB drilling parameter and the drilling parameter associated with the RPM of the drillstring rotation speed. After converting the figure into WOB vs RPM (absolute values), the set point (as a WOB-RPM pair) can be selected to minimize the impact value considering constraints other than vibration mitigation.

In some instances, vibrational advisory system 202 may generate, based on cumulative vibrational information, the impact maps and/or integrated impact maps prior to the start of one or more fracturing operations or stages by a drilling assembly. In such instances, vibrational advisory system 202 or computing device 208 may determine or recommend a setpoint or a value of a drilling parameter based on a corresponding impact map or integrated impact map. In instances where vibrational advisory system 202 may determine a setpoint or a value of a drilling parameter based on a corresponding impact map or integrated impact map, vibrational advisory system 202 may determine a setpoint or value of a drilling parameter, such as a drilling parameter associated with WOB, within a zone associated with a safe operating state of components associated with the drilling parameter. For instance, and referring to impact map 900, vibrational advisory system 202 may select a setpoint or value of a drilling parameter associated with WOB and the drilling parameter associated with the RPM of the drillstring rotation speed within first zone 901. In another instance and referring to integrated impact map 1100, vibrational advisory system 202 may select a setpoint or value of a drilling parameter associated with WOB within first zone 1101.

In some cases, vibrational advisory system 202 may recommend a setpoint or value of a drilling parameter, such as a drilling parameter associated with WOB, within a zone associated with a safe operating state of components associated with the drilling parameter. For instance, and referring to integrate impact map 1100, computing device 208 may automatically select a setpoint or value of a drilling parameter associated with WOB and a drilling parameter associated with the RPM of the drillstring rotation speed within first zone 1101. Moreover, vibrational advisory system 202 may provide integrated impact map 1100 and the selected setpoint or value of the drilling parameter associated with WOB and the drilling parameter associated with the RPM of the drillstring rotation speed to computing device 208. Computing device 208 may display integrated impact map 1100 and the selected setpoint or value of the drilling parameter associated with WOB and the drilling parameter associated with the RPM of the drillstring rotation speed. An operator of computing device 208 may provide input to computing device 208 indicating confirmation of the selected/recommend setpoint or value for the drilling parameter associated with WOB and the drilling parameter associated with the RPM of the drillstring rotational speed, or alternatively, may provide input adjusting the selected/recommend setpoint or value for the drilling parameter associated with WOB and the drilling parameter associated with the RPM of the drillstring rotational speed.

In instances where computing device 208 may determine or recommend a setpoint or a value of a drilling parameter based on a corresponding impact map or integrated impact map, vibrational advisory system 202 may generate the impact map or integrated impact map. Moreover, vibrational advisory system 202 may transmit the impact map or integrated impact map to computing device 208. In some instances, computing device 208 may automatically determine a setpoint or value of a drilling parameter, such as a drilling parameter associated with WOB, within a zone associated with a safe operating state of components associated with the drilling parameter. For instance, and referring to integrate impact map 1000, computing device 208 may automatically select a setpoint or value of a drilling parameter and associated with WOB and a drilling parameter associated with the RPM of the drillstring rotation speed within first zone 1001. In some aspects, an operator of computing device 208 may select a setpoint or value of the drilling parameter based on the impact map or integrated impact map. For instance, and referring to FIG. 9, computing device 208 may display impact map 900. Moreover, an operator of computing device 208 may provide input to computing device 208 indicating a setpoint or value for the drilling parameter associated with WOB.

In some instances, computing device 208 may automatically recommend a setpoint or value of a drilling parameter, such as a drilling parameter associated with WOB, within a zone associated with a safe operating state of components associated with the drilling parameter. For instance, and referring to integrate impact map 900, computing device 208 may automatically select a setpoint or value of a drilling parameter associated with WOB within first zone 901. Moreover, computing device 208 may display impact map 900 and the selected/recommended setpoint or value of the drilling parameter associated with WOB. An operator of computing device 208 may provide input to computing device 208 indicating confirmation of the selected/recommend setpoint or value for the drilling parameter associated with WOB, or alternatively, may provide input adjusting the selected/recommend setpoint or value for the drilling parameter associated with WOB.

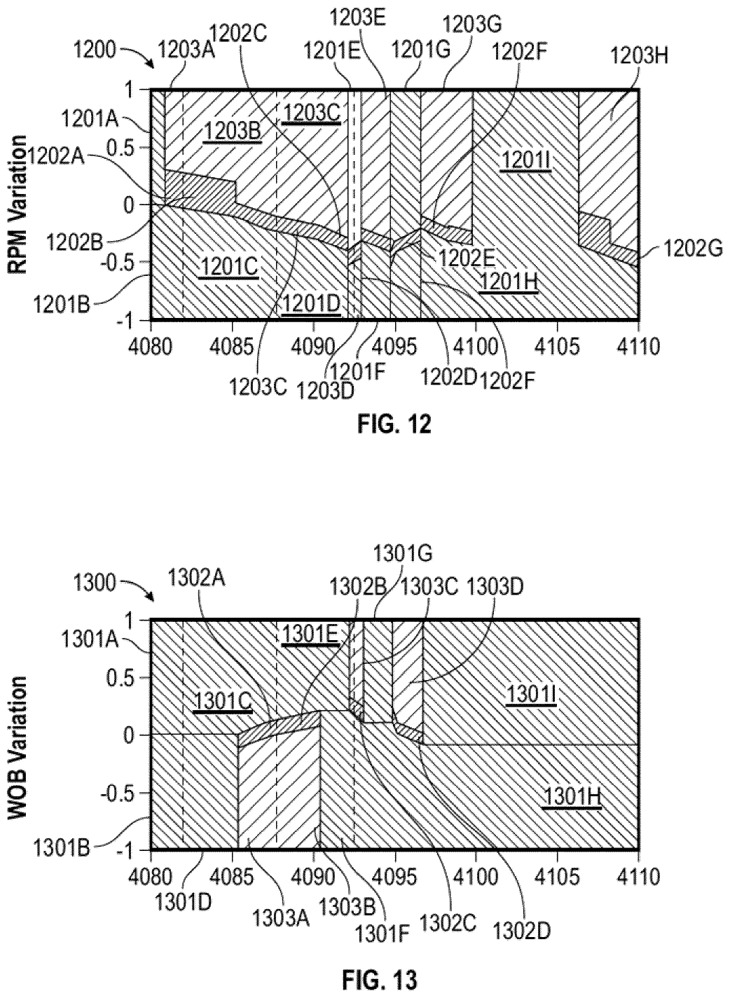

In some instances, vibrational advisory system 202 may generate, based on cumulative vibrational information, the impact maps in real-time or near real-time. For example, and referring to FIG. 12, vibrational advisory system 202 may generate example impact map 1200 based on corresponding cumulative vibrational information. Impact map 1200 may be generated in real time or near real-time by vibrational advisory system 202 based on corresponding cumulative vibrational information. Moreover, impact map 1200 may illustrate an example relationship between the severity level of slip-stick experienced by the drilling assembly and a drilling parameter associated with the RPM of the drillstring rotation speed. As illustrated in FIG. 12, first zone 1201 (e.g., first zone 1201A, first zone 1201B, first zone 1201C, first zone 1201D, first zone 1201E, first zone 1201F, first zone 1201G, first zone 1201H, and/or first zone 12011) may be associated with a safe operating state of a component associated with the drilling parameter associated with the RPM of the drillstring rotation speed, second zone 1202 (e.g., second zone 1202A, second zone 1202B, second zone 1202C, second zone 1202D, second zone 1202E, second zone 1202F, second zone 1202G, and second zone 1202H) may be associated with an intermediate operating state of a component associated with drilling parameter associated with the RPM of the drillstring rotation speed, and third zone 1203 (e.g., third zone 1203A, third zone 1203B, third zone 1203C, third zone 1203D, third zone 1203E, third zone 1203F, third zone 1203g, and third zone 1203H) may be associated with a dangerous operating state of the component associated with the drilling parameter associated with the RPM of the drillstring rotation speed. Further, FIG. 12 illustrates three time instances of interest (e.g., time instance 1204, time instance 1206, and time instance 1208) and at each time instance, vibrational advisory system 202 may generate the corresponding subsequent portions of impact map 1200 based on corresponding determined/generated cumulative vibrational information.

In another example, and referring to FIG. 13, vibrational advisory system 202 may generate example impact map 1300 based on corresponding cumulative vibrational information. Impact map 1300 may be generated in real time or near real-time by vibrational advisory system 202 based on corresponding cumulative vibrational information. Moreover, impact map 1300 may illustrate an example relationship between the severity level of whirling experienced by the drilling assembly and a drilling parameter associated with WOB. As illustrated in FIG. 13, first zone 1301 (e.g., first zone 1301A, first zone 1301B, first zone 1301C, first zone 1301D, first zone 1301E, first zone 1301F, first zone 1301G, first zone 1301H, and/or first zone 1301I) may be associated with a safe operating state of a component associated with the drilling parameter associated with WOB, second zone 1302 (e.g., second zone 1302A, second zone 1302B, second zone 1302C, and second zone 1302D) may be associated with an intermediate operating state of a component associated with drilling parameter associated with WOB, and third zone 1303 (e.g., third zone 1303A, third zone 1303B, third zone 1303C, and third zone 1303D) may be associated with a dangerous operating state of the component associated with the drilling parameter associated with WOB. Further, FIG. 13 illustrates three time instances of interest (e.g., time instance 1304, time instance, 1306 and time instance 1308) and at each time instance, vibrational advisory system 202 may generate the corresponding subsequent portions of impact map 1300 based on corresponding determined/generated cumulative vibrational information.

In some aspects, vibrational advisory system 202 or computing device 208 may perform any of the example processes described herein to determine or recommend a setpoint value of a drilling parameter based on a corresponding impact map or integrated impact map generated in real-time or near real-time. Moreover, vibrational advisory system 202 or computing device 208 may adjust the setpoint value of the drilling parameter based on the corresponding impact map or integrated impact map generated in real-time or near real-time. For instance, and referring to FIG. 12, at time instance 1204, vibrational advisory system 202 or computing device 208 may have selected a setpoint or value of a drilling parameter associated with RPM of the drillstring rotation speed within first zone 1201A. However, at time instance 1206, the selected set point or value of the drilling parameter associated with RPM of the drillstring rotation speed may now be in second zone 1202B or third zone 1203B. In some instances, vibrational advisory system 202 or computing device 208 may automatically adjust the set point or value of the drilling parameter associated with RPM of the drillstring rotation speed to be within first zone 1201C. That way, the corresponding components may avoid experiencing the severe level of stick-slip vibration.

In some instances, vibrational advisory system 202 or computing device 208 may automatically recommend adjustments to the setpoint or value of the drilling parameter associated with RPM of the drillstring rotation speed to be within first zone 1201C. In instances where vibrational advisory system 202 is making the recommendation, vibrational advisory system 202 may provide impact map 1200 at time instance 1204 along with the recommended adjustments to computing device 208. Moreover, computing device 208 may display impact map 1200 at time instance 1204 along with the recommended adjustments. Further, an operator of computing device 208 may provide input to confirm the adjustments or alternatively, may provide input adjusting the selected/recommend setpoint or value for the drilling parameter associated with RPM of the drillstring rotation speed to be within first zone 1201C.

In instances where computing device 208 is making the recommendation, computing device 208 may display impact map 1200 at time instance 1204 along with the recommended adjustments. Moreover, an operator of computing device 208 may provide input to confirm the adjustments or alternatively, may provide input adjusting the selected/recommend setpoint or value for the drilling parameter associated with RPM of the drillstring rotation speed to be within first zone 1201C.

Referring back to FIG. 2, vibrational advisory system 202 or computing device 208 may generate parameter data indicating the selected/adjusted, and in some instances, confirmed, setpoint or value of one or more drilling parameters. Moreover, vibrational advisory system 202 or computing device 208 may provide the parameter data to the BHA (e.g., the computing devices of the BHA). Based on the parameter data, the BHA (e.g., the computing devices of the BHA) may set or adjust corresponding components based on the parameter data. For instance, the parameter data may indicate adjustments to the setpoint or value of a drilling parameter associated with WOB. Moreover, the BHA may adjust the performance or operation of the corresponding component based on the parameter data.

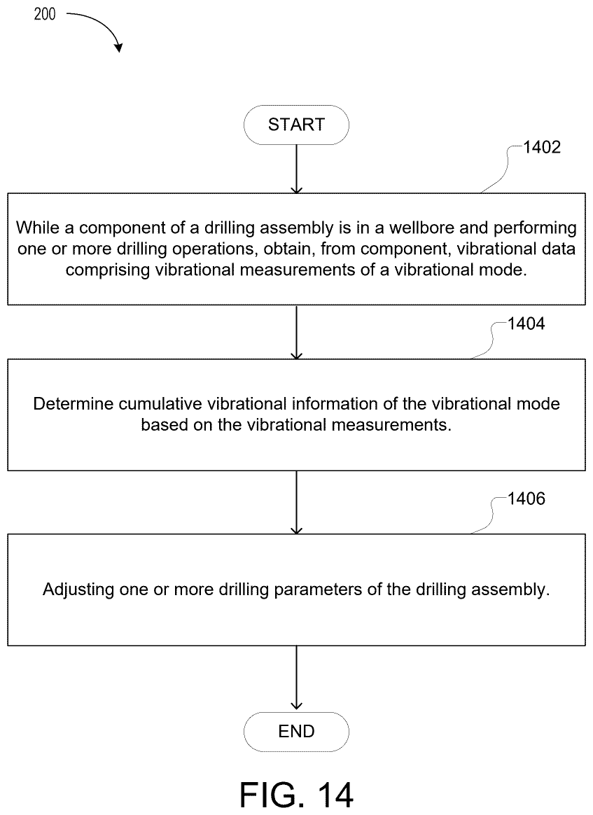

FIG. 14 is a flowchart of an example process 1400 for determining or identifying cumulative vibrational information of a particular type or mode of vibration a drilling system may be experiencing while operating within a wellbore environment. In some instances, one or more components of system 200 may perform all or a portion of the steps of example process 1400, which include but are not limited to obtaining vibrational data comprising vibrational measurements of a vibrational mode, determining cumulative vibrational information of the vibrational mode and adjusting one or more drilling parameters of a drilling device.

In some examples, while a component of a drilling assembly is in a wellbore and performing one or more drilling operations, vibrational advisory system 202 may obtain, from the component, vibrational data (e.g., step 1402 of FIG. 14). In some aspects, the component may include a BHA. Moreover, the vibrational data may include updated vibration log as described herein. Further, the updated vibration log may include vibrational measurements of a mode or type of a vibration the drilling assembly may be experiencing, such as each instance the mode or type of vibration was detected, a corresponding severity level and corresponding timestamp of when the mode or type of vibration was detected.

Moreover, vibrational advisory system 202 may determine cumulative vibrational information of the vibrational mode (e.g., step 1404 of FIG. 14). In some cases, vibrational advisory system 202 may determine the cumulative vibrational information of the vibrational mode based on the vibrational measurements of the mod or type of vibration the drilling assembly may be experiencing. As described herein, the cumulative vibrational information may include information about a mode or type of vibration the drilling system may be experiencing for a duration of time and the severity of the mode or type of vibration the drilling system is experiencing. Moreover, the cumulative vibrational information may indicate the cumulative severity level the drilling assembly may have experience or is experiencing, including an accumulation severity rate.

Further, vibrational advisory system 202 may adjust one or more drilling parameters of the drilling assembly (e.g., step 1406 of FIG. 14). In some cases, vibrational advisory system 202 may adjust one or more drilling parameters of the drilling assembly based on the cumulative vibrational information. Moreover, vibrational advisory system 202 may transmit commands or instructions including the adjustments to the drilling assembly, such as the BHA. Further, the drilling assembly may adjust the one or more drilling parameters in accordance with the command or instructions received from vibrational advisory system 202.

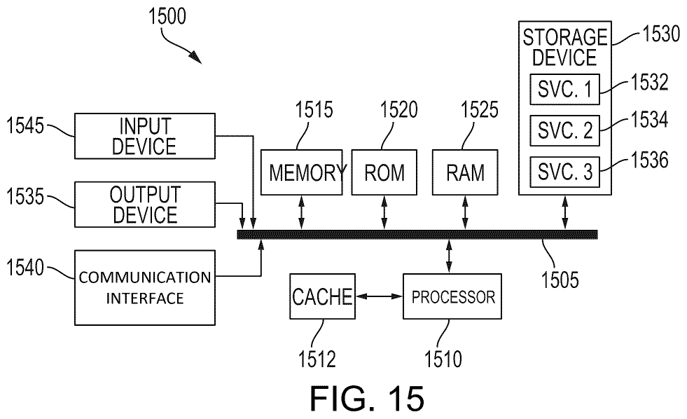

FIG. 15 illustrates an example computing device architecture 1500 which can be employed to perform various steps, methods, and techniques disclosed herein. Specifically, the computing device architecture can be integrated with the electromagnetic imager tools described herein. Further, the computing device can be configured to implement the techniques of controlling borehole image blending through machine learning described herein.

As noted above, FIG. 15 illustrates an example computing device architecture 1500 of a computing device which can implement the various technologies and techniques described herein. The components of the computing device architecture 1500 are shown in electrical communication with each other using a connection 1505, such as a bus. The example computing device architecture 1500 includes a processing unit (CPU or processor) 1510 and a computing device connection 1505 that couples various computing device components including the computing device memory 1515, such as read only memory (ROM) 1520 and random access memory (RAM) 1525, to the processor 1510.

The computing device architecture 1500 can include a cache of high-speed memory connected directly with, in close proximity to, or integrated as part of the processor 1510. The computing device architecture 1500 can copy data from the memory 1515 and/or the storage device 1530 to the cache 1512 for quick access by the processor 1510. In this way, the cache can provide a performance boost that avoids processor 1510 delays while waiting for data. These and other modules can control or be configured to control the processor 1510 to perform various actions. Other computing device memory 1515 may be available for use as well. The memory 1515 can include multiple different types of memory with different performance characteristics. The processor 1510 can include any general purpose processor and a hardware or software service, such as service 1 1532, service 2 1534, and service 3 1536 stored in storage device 1530, configured to control the processor 1510 as well as a special-purpose processor where software instructions are incorporated into the processor design. The processor 1510 may be a self-contained system, containing multiple cores or processors, a bus, memory controller, cache, etc. A multi-core processor may be symmetric or asymmetric.

To enable user interaction with the computing device architecture 1500, an input device 1545 can represent any number of input mechanisms, such as a microphone for speech, a touch-sensitive screen for gesture or graphical input, keyboard, mouse, motion input, speech and so forth. An output device 1535 can also be one or more of a number of output mechanisms known to those of skill in the art, such as a display, projector, television, speaker device, etc. In some instances, multimodal computing devices can enable a user to provide multiple types of input to communicate with the computing device architecture 1500. The communications interface 1540 can generally govern and manage the user input and computing device output. There is no restriction on operating on any particular hardware arrangement and therefore the basic features here may easily be substituted for improved hardware or firmware arrangements as they are developed.

Storage device 1530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 1525, read only memory (ROM) 1520, and hybrids thereof. The storage device 1530 can include services 1532, 1534, 1536 for controlling the processor 1510. Other hardware or software modules are contemplated. The storage device 1530 can be connected to the computing device connection 1505. In one aspect, a hardware module that performs a particular function can include the software component stored in a computer-readable medium in connection with the necessary hardware components, such as the processor 1510, connection 1505, output device 1535, and so forth, to carry out the function.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool. Additionally, the illustrate embodiments are illustrated such that the orientation is such that the right-hand side is downhole compared to the left-hand side.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:
Aspect 1. A method comprising: obtaining, from a component of a drilling assembly while the component is in a wellbore and performing one or more drilling operations, vibrational data comprising vibrational measurements of a vibrational mode; determining cumulative vibrational information of the vibrational mode based on the vibrational measurements, the cumulative vibrational information identifying and characterizing, for each of a plurality of instances during a time interval an accumulated severity of the vibrational mode; and adjusting one or more drilling parameters of the drilling assembly based on the cumulative vibrational information.
Aspect 2. The method of aspect 1, wherein determining the cumulative vibrational information of the vibrational mode includes: determining, for each of the plurality of instances, a severity of the vibrational mode based on the vibrational measurements; wherein the accumulated severity of the vibrational mode for each of the plurality of instances is based on the severity of the vibrational mode for each of the plurality of instances.
Aspect 3. The method of aspect 2, wherein determining the cumulative vibrational information of the vibrational mode includes: determining, for each of the plurality of instances, an accumulation rate based on the accumulated severity of the vibrational mode for each of the plurality of instances.
Aspect 4. The method of aspect 3, wherein determining the cumulative vibrational information of the vibrational mode includes: determining one or more characteristics of the vibrational mode based on the accumulation rate.
Aspect 5. The method of aspect 4, wherein the one or more characteristics includes at least one of a ramp-up, persistence, ramp-down, no event or any combination thereof.
Aspect 6. The method of any of aspects 1 through 5, wherein the vibrational data includes vibrational measurements of a second vibrational mode, and wherein the method further comprises: determining cumulative vibrational information of the second vibrational mode based on the vibrational measurements of the second vibrational mode, the cumulative vibrational information of the second vibrational mode identifies and characterizes, for each of a second set of instances during a second time interval an accumulated severity of the second vibrational mode; wherein adjusting the one or more drilling parameters of the drilling assembly is further based on the cumulative vibrational information of the second vibrational mode.
Aspect 7. The method of any of aspects 1 through 6, further comprising: generating an impact map based on the cumulative vibrational information, the impact map characterizing a relationship between one or more drilling parameters and the vibrational mode.
Aspect 8. The method of any of aspects 1 through 7, wherein the one or more drilling parameters includes at least one of weight on bit (WOB) parameter, rotations per minute (RPM) parameter, flow rate, or rate of penetration parameter.
Aspect 9. The method of any of aspects 1 through 8, wherein the vibrational mode is associated with at least one of an axial vibration mode, a lateral vibration mode or a torsional vibration mode.
Aspect 10. The method of aspect 9, wherein the vibrational mode is at least one of low frequency torsional oscillation, high frequency torsional oscillation, bit bounce, bit forward whirl, bit backward whirl, forward Bottom-Hole Assembly (BHA) whirl, backward BHA whirl, lateral shocks or modal coupling.
Aspect 11. A computing system comprising: a communications interface; a memory storing instructions; and at least one processor coupled to the communications interface and the memory, the at least one processor being configured to execute the instructions to: obtain, from a component of a drilling assembly while the component is in a wellbore and performing one or more drilling operations, vibrational data comprising vibrational measurements of a vibrational mode; determine cumulative vibrational information of the vibrational mode based on the vibrational measurements, the cumulative vibrational information identifying and characterizing, for each of a plurality of instances during a time interval an accumulated severity of the vibrational mode; and adjust one or more drilling parameters of the drilling assembly based on the cumulative vibrational information.
Aspect 12. The computing system of aspect 11, wherein to determining the cumulative vibrational information of the vibrational mode, and wherein the at least one processor is configured to execute the instructions to: determine the cumulative vibrational information of the vibrational mode includes: determine, for each of the plurality of instances, a severity of the vibrational mode based on the vibrational measurements; wherein the accumulated severity of the vibrational mode for each of the plurality of instances is based on the severity of the vibrational mode for each of the plurality of instances.
Aspect 13. The computer system of aspect 12, wherein to determining the cumulative vibrational information of the vibrational mode the at least one processor is configured to execute the instructions to: determine, for each of the plurality of instances, an accumulation rate based on the accumulated severity of the vibrational mode for each of the plurality of instances.
Aspect 14. The computer system of aspect 13, wherein to determine the cumulative vibrational information of the vibrational mode the at least one processor is configured to execute the instructions to: determine one or more characteristics of the vibrational mode based on the accumulation rate.
Aspect 15. The computer system of aspect 14, wherein the one or more characteristics includes at least one of a ramp-up, persistence, ramp-down, no event or any combination thereof.
Aspect 16. The computer system of any of aspects 11 through 15, wherein the vibrational data includes vibrational measurements of a second vibrational mode, and wherein the at least one processor is configured to execute the instructions to: determine cumulative vibrational information of the second vibrational mode based on the vibrational measurements of the second vibrational mode, the cumulative vibrational information of the second vibrational mode identifies and characterizes, for each of a second set of instances during a second time interval an accumulated severity of the second vibrational mode; wherein adjusting the one or more drilling parameters of the drilling assembly is further based on the cumulative vibrational information of the second vibrational mode.
Aspect 17. The computer system of any of aspects 11 through 16, wherein the at least one processor is configured to execute the instructions to: generate an impact map based on the cumulative vibrational information, the impact map characterizing a relationship between one or more drilling parameters and the vibrational mode.
Aspect 18. The computer system of any of aspects 11 through 17, wherein the one or more drilling parameters includes at least one of weight on bit (WOB) parameter, rotations per minute (RPM) parameter, flow rate, or rate of penetration parameter.
Aspect 19. The computer system of any of aspects 11 through 18, wherein the vibrational mode is associated with at least one of an axial vibration mode, a lateral vibration mode or a torsional vibration mode.
Aspect 20. A tangible, non-transitory computer readable medium storing instructions that, when executed by at least one processor, cause the at least one processor to perform operations comprising: obtaining, from a component of a drilling assembly while the component is in a wellbore and performing one or more drilling operations, vibrational data comprising vibrational measurements of a vibrational mode; determining cumulative vibrational information of the vibrational mode based on the vibrational measurements, the cumulative vibrational information identifying and characterizing, for each of a plurality of instances during a time interval an accumulated severity of the vibrational mode; and adjusting one or more drilling parameters of the drilling assembly based on the cumulative vibrational information.
Aspect 21. A system comprising means for performing a method according to any of aspects 1 through 10.

What is claimed is:

1. A method comprising:
obtaining, from a component of a drilling assembly while the component is in a wellbore and performing one or more drilling operations, vibrational data comprising vibrational measurements of a vibrational mode;
determining cumulative vibrational information of the vibrational mode based on the vibrational measurements, the cumulative vibrational information identifying and characterizing, for each of a plurality of instances during a time interval an accumulated severity of the vibrational mode; and
adjusting one or more drilling parameters of the drilling assembly based on the cumulative vibrational information.

2. The method of claim 1, wherein determining the cumulative vibrational information of the vibrational mode includes:
determining, for each of the plurality of instances, a severity of the vibrational mode based on the vibrational measurements;
wherein the accumulated severity of the vibrational mode for each of the plurality of instances is based on the severity of the vibrational mode for each of the plurality of instances.

3. The method of claim 2, wherein determining the cumulative vibrational information of the vibrational mode includes:
determining, for each of the plurality of instances, an accumulation rate based on the accumulated severity of the vibrational mode for each of the plurality of instances.

4. The method of claim 3, wherein determining the cumulative vibrational information of the vibrational mode includes:
determining one or more characteristics of the vibrational mode based on the accumulation rate.

5. The method of claim 4, wherein the one or more characteristics includes at least one of a ramp-up, persistence, ramp-down, no event or any combination thereof.

6. The method of claim 1, wherein the vibrational data includes vibrational measurements of a second vibrational mode, and wherein the method further comprises:
determining cumulative vibrational information of the second vibrational mode based on the vibrational measurements of the second vibrational mode, the cumulative vibrational information of the second vibrational mode identifies and characterizes, for each of a second set of instances during a second time interval an accumulated severity of the second vibrational mode;
wherein adjusting the one or more drilling parameters of the drilling assembly is further based on the cumulative vibrational information of the second vibrational mode.

7. The method of claim 1, further comprising:
generating an impact map based on the cumulative vibrational information, the impact map characterizing a relationship between one or more drilling parameters and the vibrational mode.

8. The method of claim 1, wherein the one or more drilling parameters includes at least one of weight on bit (WOB) parameter, rotations per minute (RPM) parameter, flow rate, or rate of penetration parameter.

9. The method of claim 1, wherein the vibrational mode is associated with at least one of an axial vibration mode, a lateral vibration mode or a torsional vibration mode.

10. The method of claim 9, wherein the vibrational mode is at least one of low frequency torsional oscillation, high frequency torsional oscillation, bit bounce, bit forward whirl, bit backward whirl, forward Bottom-Hole Assembly (BHA) whirl, backward BHA whirl, lateral shocks or modal coupling.

11. A computing system comprising:
a communications interface;
a memory storing instructions; and
at least one processor coupled to the communications interface and the memory, the at least one processor being configured to execute the instructions to:
obtain, from a component of a drilling assembly while the component is in a wellbore and performing one or more drilling operations, vibrational data comprising vibrational measurements of a vibrational mode;
determine cumulative vibrational information of the vibrational mode based on the vibrational measurements, the cumulative vibrational information identifying and characterizing, for each of a plurality of instances during a time interval an accumulated severity of the vibrational mode; and
adjust one or more drilling parameters of the drilling assembly based on the cumulative vibrational information.

12. The computing system of claim 11, wherein to determining the cumulative vibrational information of the vibrational mode, and wherein the at least one processor is configured to execute the instructions to:
determine the cumulative vibrational information of the vibrational mode includes:
determine, for each of the plurality of instances, a severity of the vibrational mode based on the vibrational measurements;
wherein the accumulated severity of the vibrational mode for each of the plurality of instances is based on the severity of the vibrational mode for each of the plurality of instances.

13. The computing system of claim 12, wherein to determining the cumulative vibrational information of the vibrational mode the at least one processor is configured to execute the instructions to:
determine, for each of the plurality of instances, an accumulation rate based on the accumulated severity of the vibrational mode for each of the plurality of instances.

14. The computing system of claim 13, wherein to determine the cumulative vibrational information of the vibrational mode the at least one processor is configured to execute the instructions to:
determine one or more characteristics of the vibrational mode based on the accumulation rate.

15. The computing system of claim 14, wherein the one or more characteristics includes at least one of a ramp-up, persistence, ramp-down, no event or any combination thereof.

16. The computing system of claim 11, wherein the vibrational data includes vibrational measurements of a second vibrational mode, and wherein the at least one processor is configured to execute the instructions to:
determine cumulative vibrational information of the second vibrational mode based on the vibrational measurements of the second vibrational mode, the cumulative vibrational information of the second vibrational mode identifies and characterizes, for each of a second set of instances during a second time interval an accumulated severity of the second vibrational mode;
wherein adjusting the one or more drilling parameters of the drilling assembly is further based on the cumulative vibrational information of the second vibrational mode.

17. The computing system of claim 11, wherein the at least one processor is configured to execute the instructions to:
generate an impact map based on the cumulative vibrational information, the impact map characterizing a relationship between one or more drilling parameters and the vibrational mode.

18. The computing system of claim 11, wherein the one or more drilling parameters includes at least one of weight on bit (WOB) parameter, rotations per minute (RPM) parameter, flow rate, or rate of penetration parameter.

19. The computing system of claim 11, wherein the vibrational mode is associated with at least one of an axial vibration mode, a lateral vibration mode or a torsional vibration mode.

20. A tangible, non-transitory computer readable medium storing instructions that, when executed by at least one processor, cause the at least one processor to perform operations comprising:
obtaining, from a component of a drilling assembly while the component is in a wellbore and performing one or more drilling operations, vibrational data comprising vibrational measurements of a vibrational mode;
determining cumulative vibrational information of the vibrational mode based on the vibrational measurements, the cumulative vibrational information identifying and characterizing, for each of a plurality of instances during a time interval an accumulated severity of the vibrational mode; and
adjusting one or more drilling parameters of the drilling assembly based on the cumulative vibrational information.
